(19) United States
(12) Patent Application Publication
(10) Pub. No.: US 2008/0297509 A1
(43) Pub. Date: Dec. 4, 2008

(54) IMAGE PROCESSING METHOD AND IMAGE PROCESSING PROGRAM

(75) Inventor: Kazuhiko Matsumoto, Tokyo (JP)

Correspondence Address: PEARNE & GORDON LLP, 1801 EAST 9TH STREET, SUITE 1200, CLEVELAND, OH, 44114-3108, US

(73) Assignee: ZIOSOFT, INC., Tokyo (JP)

(21) Appl. No.: 12/127,307

(22) Filed: May 27, 2008

(30) Foreign Application Priority Data
May 28, 2007 (JP) 2007-140161

(51) Int. Cl. G06T 17/00

(52) U.S. Cl. 345/424

(57) ABSTRACT

In an image processing method of visualizing information of a living body near an imaginary path, the image processing method includes: creating a cylindrical cross-sectional image on a cylindrical cross section defined by a reference distance from the imaginary path; creating a cylindrical projection image according to said imaginary path; combining the cylindrical cross-sectional image and the cylindrical projection image; and displaying the combined image.

This application is based on and claims priority from Japanese Patent Application No. 2007-140161, filed on May 28, 2007, the entire contents of which are hereby incorporated by reference.

### BACKGROUND

1. Technical Field

This invention relates to an image processing method and an image processing program and in particular to an image processing method and an image processing program for enabling the user to simultaneously observe the inside of a wall and the inner wall surface of a tubular tissue with a large number of bending curvatures such as the colon.

2. Related Arts

Computed Tomography (CT) and Magnetic Resonance Imaging (MRI), which make it possible to directly observe the internal structure of a human body, have brought about an innovation in the medical field according to the image processing technology using a computer, and medical diagnosis using the tomographic image of a living body has been widely conducted. Further, volume rendering has been used for medical diagnosis in recent years. The volume rendering enables to visualize the complicated three-dimensional structure of the inside of a human body, which is hard to understand simply from the tomographic image of the human body. For example, the volume rendering enables to directly render an image of the three-dimensional structure from three-dimensional digital data (volume data) of an object obtained by CT.

Raycast method, Maximum Intensity Projection (MIP) method, and Minimum Intensity Projection (MINIP) are available for the volume rendering. Multi Planar Reconstruction (MPR) and Curved Planar Reconstruction (CPR) can be used as two-dimensional image processing using volume data. Further, a 2D slice image, etc., is generally used as two-dimensional image processing.

A minute unit region used as an element unit of a three-dimensional region of an object is called voxel and unique data representing the characteristic of the voxel is called voxel value. The whole object is represented by a three-dimensional data array of the voxel values, and which is called volume data. The volume data used for volume rendering is obtained by stacking two-dimensional tomographic image data provided in sequence along the direction perpendicular to the tomographic plane of the object. Particularly for a CT image, the voxel value represents the absorption degree of radiation at the position occupied by the voxel in the object and is called CT value.

The raycast method has been known as an excellent technique of the volume rendering. The raycast method is a technique of applying a virtual ray from the projection surface with respect to an object and then creating a virtual reflected light image from the inside of the object, thereby creating an image to see through the three-dimensional structure of the inside of the object on the projection surface.

FIGS. 17A and 17B are schematic representations for performing mask processing for a volume and then displaying only a partial region of the volume. The mask processing is used to display only a partial region of whole volume data 51 as a mask region 52, for example, as shown in FIG. 17B. For example, in an image of the colon obtained by the raycast method, a mask region obtained after removing the region obstructing field of view in front of the observation target region is specified and then mask processing is performed, whereby the outer shape of the inner wall surface of the colon can be displayed as shown in FIG. 17A.

FIGS. 18A and 18B are schematic representations for displaying an arbitrary cross section of a volume by Multi Planar Reconstruction (MPR). In the MPR an arbitrary cross section 54 can be cut out from a volume 53, for example, as shown in FIG. 18B and the cross section can be displayed according to the voxel values. FIG. 18A shows a display image of the peripheral area of the colon by MPR. Air existing in the lumen of the colon is represented by each black portion in FIG. 18A. Thus, in the MPR image, the arbitrary cross section 54 of the volume 53 is displayed, so that information on the peripheral area of a tubular tissue such as the colon can also be displayed. (see e.g., Patent Document 1.)

FIG. 19 shows a composite image of an image rendered by the raycast method (a parallel projection method) and an MPR image. The raycast image is an image as if the wall surface of a three-dimensional tissue were seen from the viewpoint outside the tissue containing the internal space of the three-dimensional tissue, in which the three-dimensional image is separated on a plane by a mask and in order to display the three-dimensional image. And, the paired MPR image with the same plane as creation of the mask as the cross section of MPR. (see e.g., Patent Document 2.) The image is useful for diagnosis because the stereoscopic shape of the tissue according to the raycast method and the neighborhood information of the tissue according to the MPR image can be displayed at the same time.

FIGS. 20A to 20C are schematic representations of cylindrical projection method using a cylindrical coordinate system. FIG. 20A shows virtual rays 56 radiated from the center axis of a cylindrical coordinate system and set in a tubular tissue 55. FIG. 20B shows a schematic representation in which the cylindrical coordinate system is represented as C (h, α) by distance h along the center axis and angle α around the center axis. FIG. 20C shows a schematic representation in which the cylindrical coordinates C (h, α) are unfolded and converted into two-dimensional coordinates 1 (u, v). Thus, the cylindrical coordinate system is assumed in the tubular tissue 55 and radial projection is conducted from the center axis, whereby a 360-degree panoramic image of the inner wall surface of the tubular tissue 55 can be created.

FIG. 21 is a drawing to describe curved cylindrical projection method when a tubular tissue 57 to be observed is curved. The curved cylindrical projection method is a certain type of cylindrical projection method. When the tubular tissue 57 to be observed is curved, the curved cylindrical projection is a method of radiating and projecting virtual ray 58 from a curved central path 14. Thus, according to the curved cylindrical projection, the central path 14 along the center line of an actual curved organ of a human being is assumed and projection is conducted with the central path as the center, whereby the tubular tissue can be inspected according to CT data.

FIG. 22 is a flowchart of cylindrical projection in a related art. In the cylindrical projection in the related art, firstly, a central path is set (step S51) and a position t on the central path is initialized as t=0 (step S52).

Next, position P (x, y, z) of the position t on the central path and direction vector PD (x, y, z) of the central path at the position t on the central path are acquired (step S53). 360-degree radial directions with P (x, y, z) as the center are acquired on the plane passing through P (x, y, z) and perpendicular to PD (x, y, z) (step S54).

In the curved cylindrical projection, PD (x, y, z) and the plane are finely adjusted to avoid interference between planes in the tissue and are not necessarily perpendicular. Further, a curved surface rather than a plane may be used. (see e.g., Non-Patent Document 1.)

Next, virtual ray is projected in 360° (step S55) and 1 is added to t (step S56) and whether or not t is smaller than t_max is determined (step S57). If t is smaller than t_max (yes), the process returns to step S53 and when t becomes t_max (no), the process is terminated.

FIG. 23 is a flowchart of virtual ray projection at step S55 in FIG. 22. To project virtual ray, firstly, sampling interval ΔS and unit vector SD (x, y, z) in the traveling direction of the virtual ray are acquired (step S61) and reflected light E is initialized to 0 and remaining light I is initialized to 1 (step S62).

Next, P (x, y, z) is set as current position X (step S63) and an interpolation voxel value v and gradient g at the position X are calculated (step S64). Opacity α and color C corresponding to v and a shading coefficient β corresponding to g are calculated (step S65).

Next, attenuation light D is set to α1 and partial reflected light F=β·α·D·C is calculated and remaining light I=I−D and reflected light E=+F are updated (step S66). The current calculation position is advanced and X=X+ΔS·SD (step S57).

Next, whether or not X reaches the end position or whether or not the remaining light I becomes 0 is determined (step S68) and if X does not reach the end position and the remaining light I is not 0 (no), the process returns to step S64. If X reaches the end position or the remaining light I becomes 0 (yes), the reflected light E is adopted as pixel value and the process is terminated.

Next, the terminology for the regions of a tubular tissue will be discussed with FIG. 24. Here, for a tubular tissue 61 of inside of the human body such as a colon, a region 63 is called “lumen,” a wall surface 64 is called “inner wall surface,” a region 65 is called “inside of wall” and a region 62 is called “inside and neighborhood of wall.” Therefore, the portion displayed in the raycast in the related art is “inner wall surface” (generally, interface) and the portion rendered by the MPR is “inside of wall” (substance of volume).

The followings are related art documents:

Patent document 1: U.S. Patent Application Publication No. 2006/0221074

Patent document 2: Japanese Patent Publication No. 3117665

Non-patent document 1: A. Vilanova Bartroli, R. Wegenkittl, A. Konig, and E. Groller: “Virtual Colon Unfolding”, IEEE Visualization, U.S.A., p 411-420, 2001.

In the mask display of a volume shown in FIGS. 17A and 17B, mask processing is performed for the volume and only a part is displayed, whereby the outer shape of the inner wall surface of the colon is displayed and a lesioned part appearing as the outer shape of the inner wall surface like a polyp can be observed or found. However, the mask display has the disadvantage in that inside and neighborhood of colon wall is not visualized.

In the MPR image shown in FIGS. 18A and 18B, an arbitrary cross section of a volume is displayed and neighbor information about a tubular tissue such as the colon can also be displayed, but the MPR image has the disadvantage in that the shape of the inside of the colon is hard to see.

Further, when superposition of an image rendered by the raycast method and an MPR image by the parallel projection method is conducted to display the surface condition and the internal condition of the inspection target at the same time as shown in FIG. 19, a given effect is provided, but it is insufficient for observing a target with a large number of bending curvatures such as the colon.

### SUMMARY

Exemplary embodiments of the present invention provide an image processing method and an image processing program for enabling the user to simultaneously observe the inside of a wall and the inner wall surface of a tubular tissue with a large number of bending curvatures such as the colon.

According to one or more aspects of the present invention, in an image processing method of visualizing information of a living body near an imaginary path, the image processing method comprises:

creating a cylindrical cross-sectional image on a cylindrical cross section defined by a reference distance from the imaginary path;

creating a cylindrical projection image according to said imaginary path;

combining the cylindrical cross-sectional image and the cylindrical projection image; and

displaying the combined image.

According to one or more aspects of the present invention, the image processing method further comprises:

determining said reference distance from the path;

acquiring a position on a circumference of a circle determined by the reference distance from the imaginary path on a plane crossing the imaginary path;

determining whether a voxel of said position represents opacity or transparency;

if said voxel represents the opacity,

acquiring a first pixel value from said voxel; and using the first pixel value to create the cylindrical cross-sectional image, and

if said voxel represents the transparency,

acquiring a second pixel value by projecting a virtual ray passing through said position; and using the second pixel value to create the cylindrical projection image.

According to one or more aspects of the present invention, the imaginary path is provided along a central path of a curved tubular tissue, and the cylindrical projection image is generated by projecting a virtual ray from the central path.

According to one or more aspects of the present invention, the image processing method further comprises: varying the reference distance through a GUI.

According to one or more aspects of the present invention, the image processing method further comprises: finding the reference distance in response to a position on the imaginary path.

According to one or more aspects of the present invention, the image processing method further comprises: determining the reference distance in response to a direction from the imaginary path.

According to one or more aspects of the present invention, in an image-analysis apparatus storing a program for executing an image processing method of visualizing information of a living body near an imaginary path, the image processing method comprises:

creating a cylindrical cross-sectional image on a cylindrical cross section defined by a reference distance from the imaginary path;

creating a cylindrical projection image according to said imaginary path;

combining the cylindrical cross-sectional image and the cylindrical projection image; and

displaying the combined image.

According to one or more aspects of the present invention, in the image-analysis apparatus, the image processing method further comprises:

determining said reference distance from the path;

acquiring a position on a circumference of a circle determined by the reference distance from the imaginary path on a plane crossing the imaginary path;

determining whether a voxel of said position represents opacity or transparency;

if said voxel represents the opacity,

acquiring a first pixel value from said voxel; and using the first pixel value to create the cylindrical cross-sectional image, and

if said voxel represents the transparency,

acquiring a second pixel value by projecting a virtual ray passing through said position; and using the second pixel value to create the cylindrical projection image.

According to one or more aspects of the present invention, in the image-analysis apparatus, the image processing method further comprises: finding the reference distance in response to a position on the imaginary path.

According to one or more aspects of the present invention, in the image-analysis apparatus, the image processing method further comprises: determining the reference distance in response to a direction from the imaginary path.

Other aspects and advantages of the invention will be apparent from the following description, the drawings and the claims.

### BRIEF DESCRIPTION OF THE DRAWINGS

In the accompanying drawings,

FIGS. 1A and 1B are drawings to describe an image processing method according to an embodiment of the invention;

FIG. 2 is a drawing to describe iterative processing on a central path in the image processing method according to the embodiment of the invention;

FIG. 3 is a drawing to describe effect (#1) of the image processing method according to the embodiment of the invention;

FIGS. 4A and 4B are drawings to show images in the image processing method according to the embodiment of the invention;

FIG. 5 is a drawing to show a composite image in the image processing method according to the embodiment of the invention;

FIG. 6 is a drawing to describe effect (#2) of the image processing method according to the embodiment of the invention;

FIGS. 7A and 7B are drawings to describe effect (#3) of the image processing method according to the embodiment of the invention;

FIGS. 8A and 8B are drawings to describe Example 1 of the image processing method according to the embodiment of the invention;

FIG. 9 is a drawing to describe Example 2 of the image processing method according to the embodiment of the invention;

FIG. 10 is a cross-sectional schematic view on a plane parallel with the central path when reference distance from the central path is automatically calculated on the position on the central path;

FIG. 11 is a drawing to describe an implementation method of example 2 of the invention;

FIG. 12 is a drawing to describe example 3 of the image processing method according to the embodiment of the invention;

FIG. 13 is a drawing to describe an implementation method of example 3 of the invention;

FIG. 14 is a flowchart of the image processing method according to examples 1 to 3 of the invention;

FIG. 15 is a flowchart when virtual ray is projected in examples 1 to 3 of the invention;

FIG. 16 is a flowchart to show another implementation method in the image processing method of the invention;

FIGS. 17A and 17B are schematic representations for performing mask processing for a volume and then displaying only a part thereof;

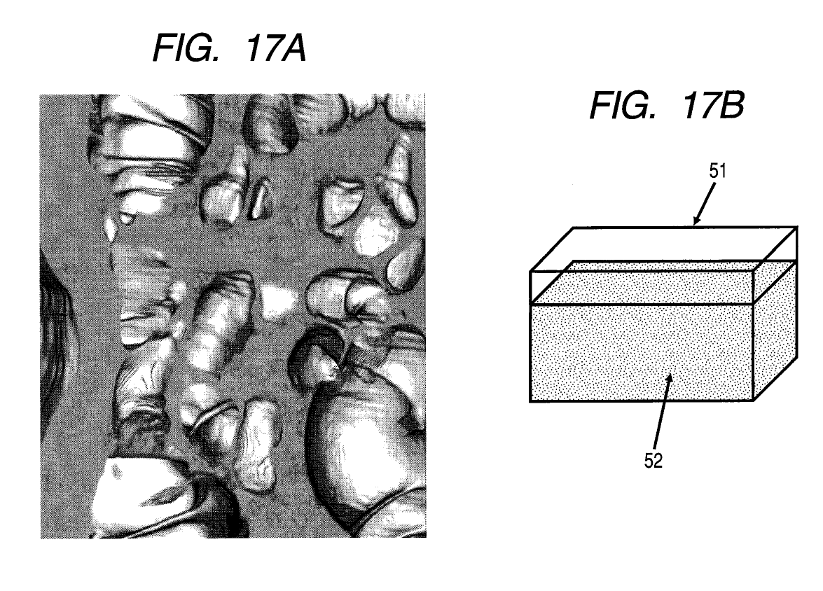

FIGS. 18A and 18B are schematic representations for displaying an arbitrary cross section of a volume by Multi Planar Reconstruction (MPR);

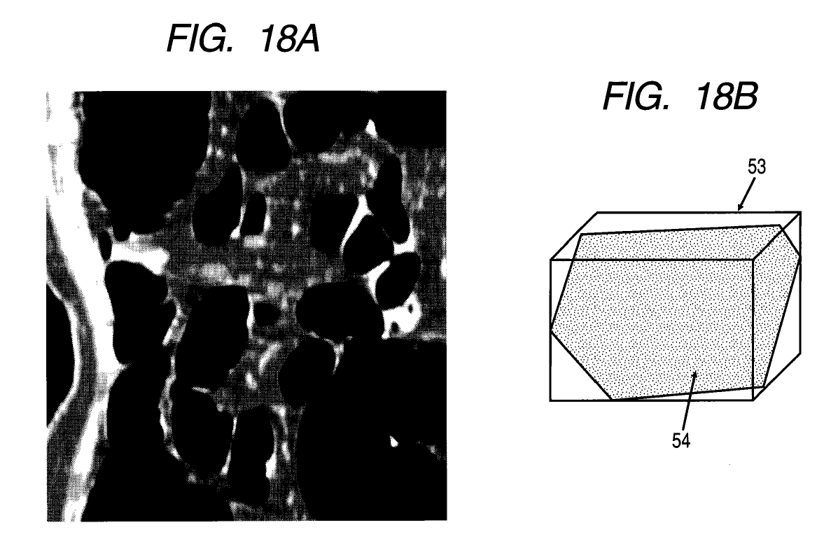

FIG. 19 is a schematic representation for superposition of a mask image and an MPR image by a parallel projection method;

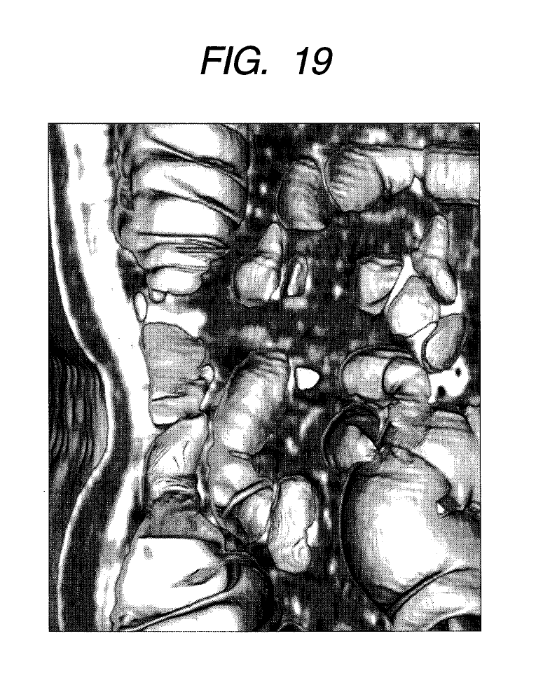

FIGS. 20A to 20C are schematic representations of cylindrical projection using a cylindrical coordinate system;

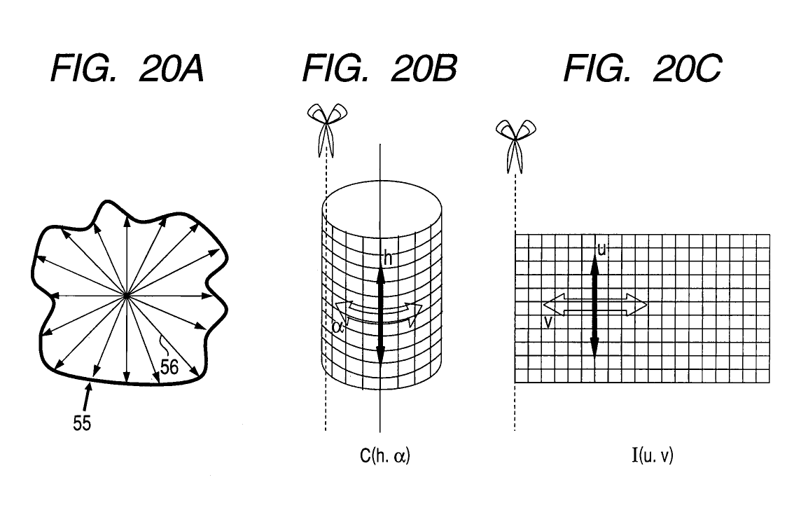

FIG. 21 is a drawing to describe curved cylindrical projection when a tubular tissue 57 to be observed is curved;

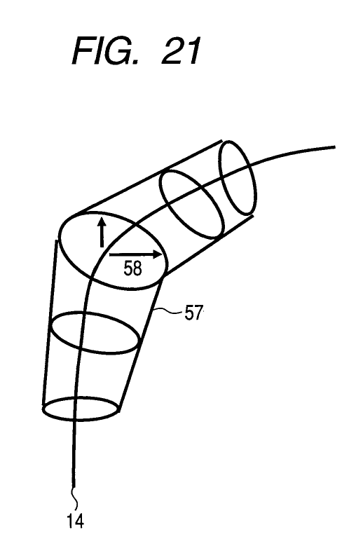

FIG. 22 is a flowchart of cylindrical projection in a related art;

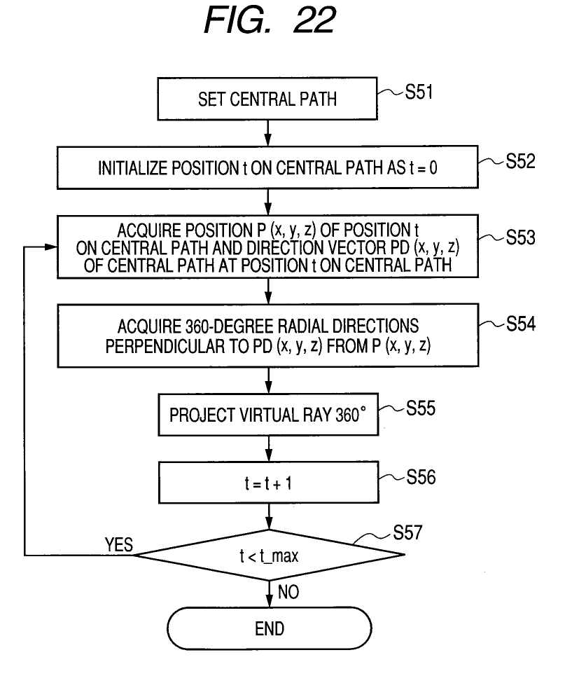

FIG. 23 is a flowchart of virtual ray projection in the related art; and

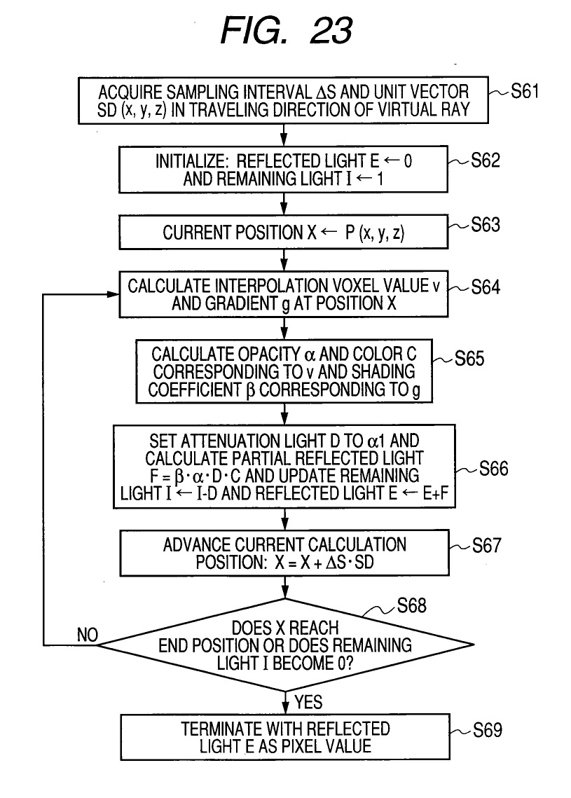

FIG. 24 is a schematic representation for describing the terminology for the regions of a tubular tissue.

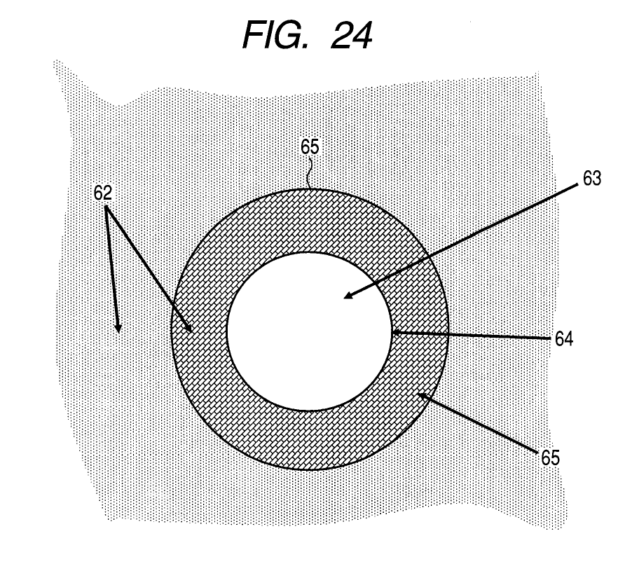

### DETAILED DESCRIPTION

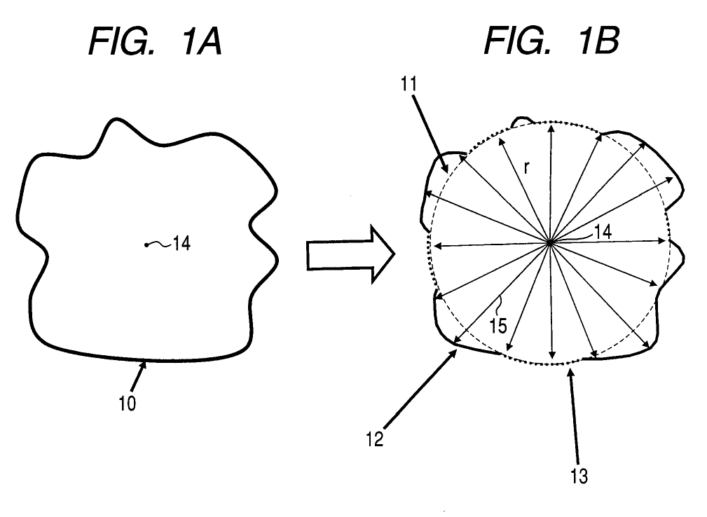

FIGS. 1A and 1B are drawings to describe an image processing method according to an embodiment of the invention FIG. 1A shows a cross-section of cutting a tubular tissue 10 on a plane crossing a central path 14 for representing the center line of the tubular tissue 10. In the image processing method of the embodiment, in case the cross-section of the tubular tissue 10 exists as shown in FIG. 1A, firstly, a range 11 determined by the circumference of a circle whose radius is reference distance r is found, where the position of the central path 14 on the cross-section is the center of the circle (namely, a set of points existing at equal distance r from the position of the central path 14 on the cross-section). Virtual ray 15 is projected onto an outside portion 12 of the reference distance r (namely, portion where the distance between the inner wall surface of the tubular tissue 10 and the position of the central path 14 on the cross-section is larger than the reference distance r) according to a raycast method and the corresponding pixel values are acquired according to a three-dimensional image technique. On a circumference 13 at the reference distance r (namely, portion where the distance between the inner wall surface of the tubular tissue 10 and the position of the central path 14 on the cross-section is smaller than the reference distance r), the voxel values on the circumference 13 are used to acquire the corresponding pixel values according to a two-dimensional cross-sectional image (in a MPR manner) technique, whereby the pixels on the circumference corresponding to the cylindrical cross section are acquired.

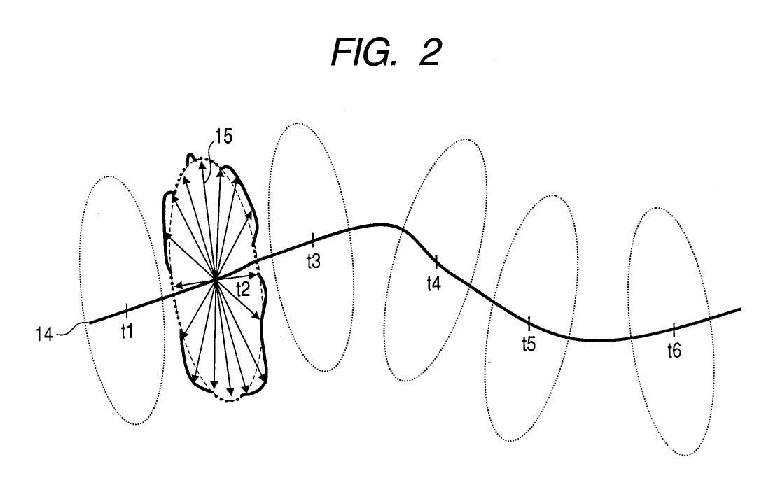

FIG. 2 is a drawing to describe iterative processing on the central path 14 in the image processing method according to the embodiment of the invention. That is, for each positions t1 to t6 of the central path 14, the circular range according to the reference distance r is achieved. Then, the virtual ray 15 is projected onto the outside portion of the circular range and the pixel values are acquired according to the three-dimensional image technique. And on the circumference at the circular range, the pixel values are acquired according to the two-dimensional cross-sectional image technique.

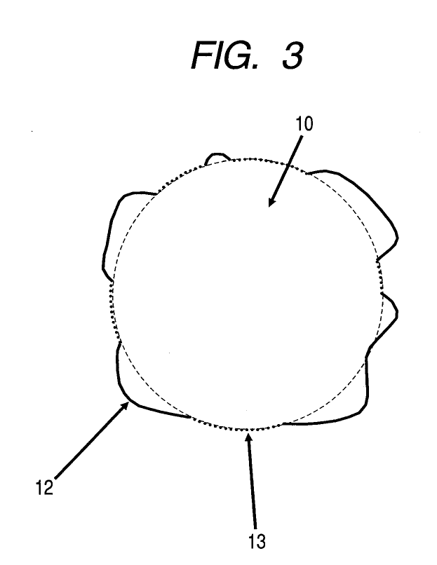

FIG. 3 is a drawing to describe effect (#1) of the image processing method according to the embodiment of the invention. According to the image processing method of the embodiment, the inside 13 of the tubular tissue 10 (cylindrical cross-sectional image) and the surface 12 (projection image) can be observed at the same time and further the tubular tissue 10 can be seen as a panoramic view over a wide range.

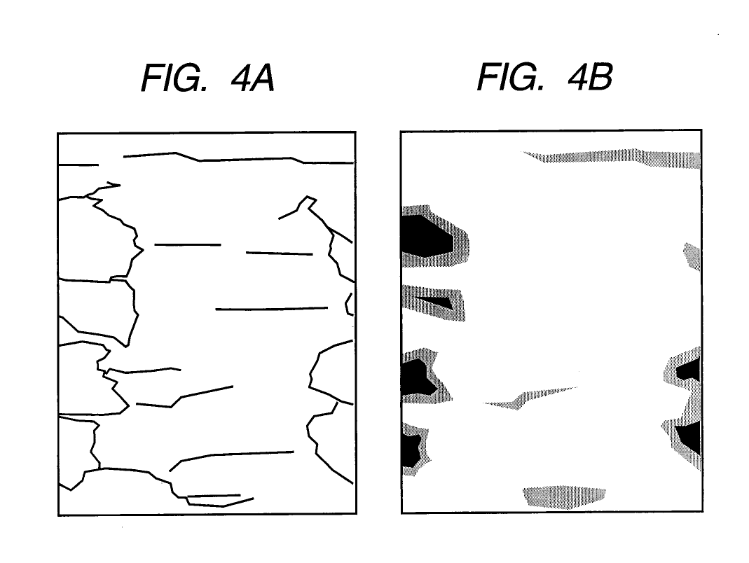

FIGS. 4A and 4B show images in the image processing method according to the embodiment of the invention. That is, FIG. 4A shows a cylindrical projection image of rendering the tubular tissue according to the cylindrical projection from the central path. FIG. 4B shows on-cylinder voxel data (similar to MPR) when the tubular tissue is cut at the reference distance r from the central path.

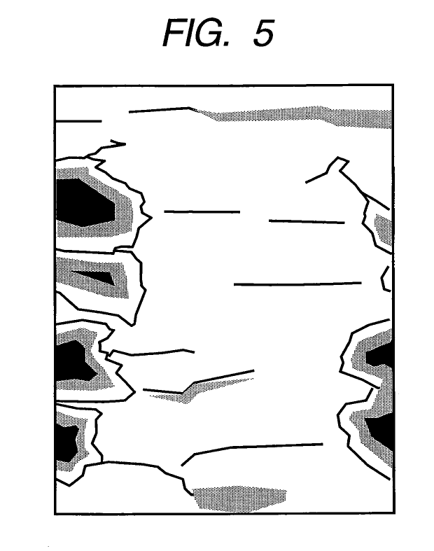

FIG. 5 shows a composite image in the image processing method according to the embodiment of the invention. Thus, the composite image in the embodiment results from rendering according to the three-dimensional image technique by projecting the virtual ray onto the outside portion of the reference distance according to the raycast method and rendering the top of the circumference at the reference distance according to the two-dimensional cross-sectional image technique using the voxel values on the circumference, so that the inside of a wall and the inner wall surface of a tubular tissue with a large number of bending curvatures such as the colon can be observed at the same time.

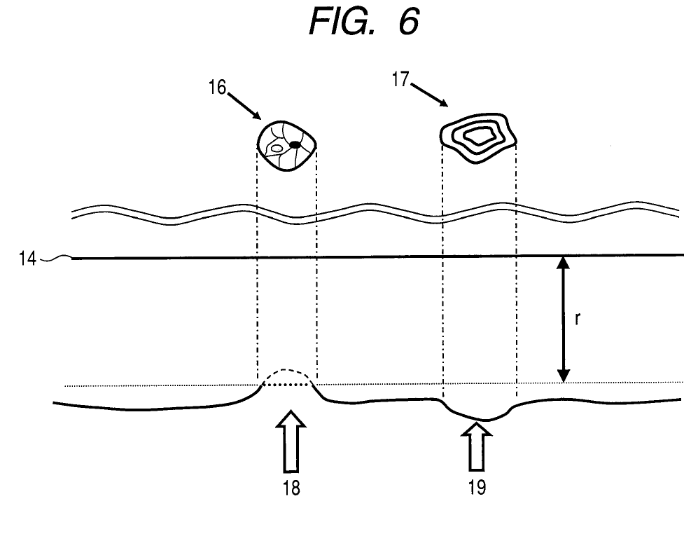

FIG. 6 is a drawing to describe effect (#2) of the image processing method according to the embodiment of the invention. In the cylindrical projection image in the related art, a virtual ray is projected from the central path 14 and the inner surface of the tubular tissue is rendered and thus it is difficult to determine whether the region on the surface is a convex part or a concave part.

According to the image processing method of the embodiment, a convex part 18 on the surface is displayed as a sectional view 16 on a parallel plane at the reference distance r from the central path 14 and a concave part 19 on the surface is displayed in a similar manner to a cylindrical projection image 17 in the related art, so that whether the region is the convex part 18 or the concave part 19 can be determined easily. The cross section responsive to the reference distance r from the central path 14 is displayed, whereby the height of the convex part 18 can be recognized easily.

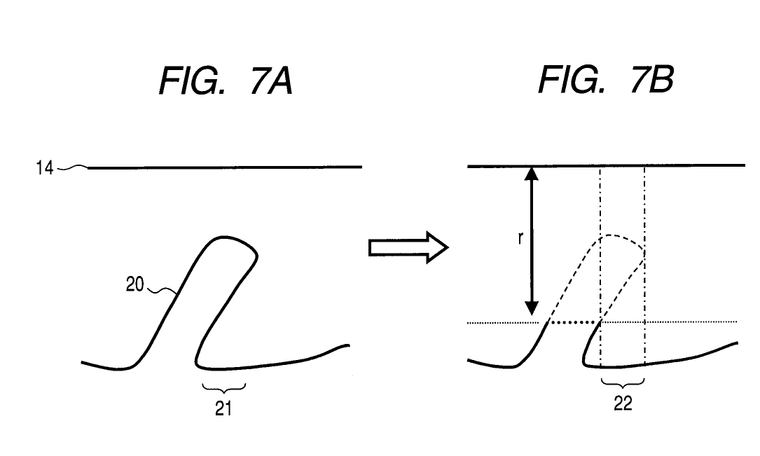

FIGS. 7A and 7B are drawings to describe effect (#3) of the image processing method according to the embodiment of the invention. For example, as shown in FIG. 7A, if a projection 20 exists on the inner surface of a tubular tissue, a range 21 as a shadow of the projection cannot be observed in a usual cylindrical projection image.

According to the image processing method of the embodiment, the tissue at the reference distance r from the central path 14 can be eliminated to render a cylindrical projection image as shown in FIG. 7B, so that a range 22 corresponding to a shadow of the tissue of the overlap shape can be observed easily.

### EXAMPLE 1

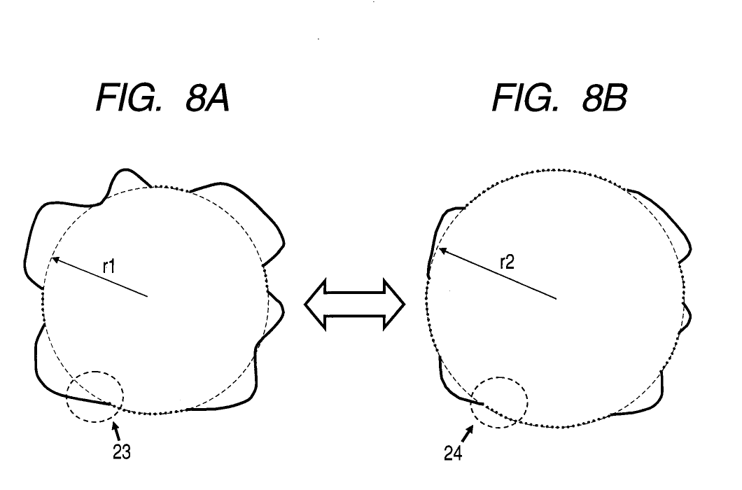

FIGS. 8A and 8B are drawings to describe example 1 of the image processing method according to the embodiment of the invention. In the image processing method of the example, the user manipulates the reference distance r from the central path through a GUI. That is, the user can dynamically set the reference distance from the central path to r1, r2 (r1<r2) while observing a tubular tissue. The image is updated instantaneously in response to the value of the newly set reference distance r.

The affected part of a tubular tissue such as the colon is often observed in a range 23 or 24 in which the cross-sectional shape changes. Thus, according to the image processing method of the example, the user can easily find the range 23 or 24, in which the cross-sectional shape changes, by manipulating the reference distance r from the central path and can efficiently observe information just below the surface of the tissue.

### EXAMPLE 2

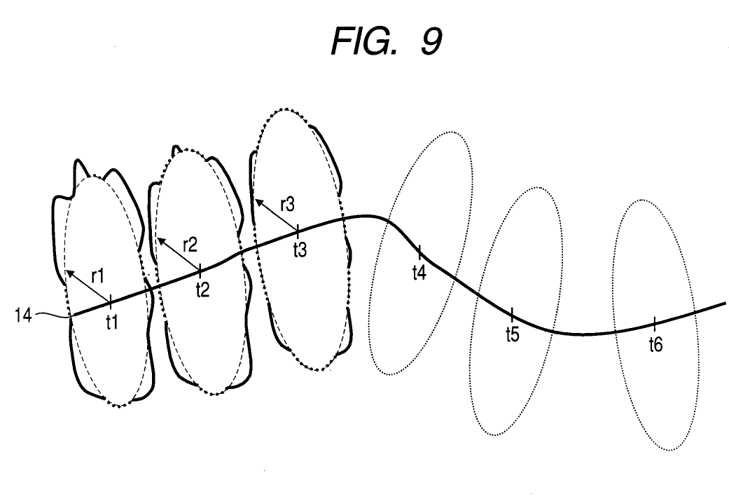

FIG. 9 is a drawing to describe example 2 of the image processing method according to the embodiment of the invention. In the image processing method of the example, the reference distance r from the central path 14 varies depending on the position on the central path 14. The distance is calculated automatically.

That is, the diameter of a tubular tissue varies from one place to another and thus reference distances r1, r2, and r3 are adjusted according to positions t1 to t6 on the central path 14. Accordingly, if the diameter of a tubular tissue varies from one place to another, a projection of the internal surface of the tubular tissue can be observed easily.

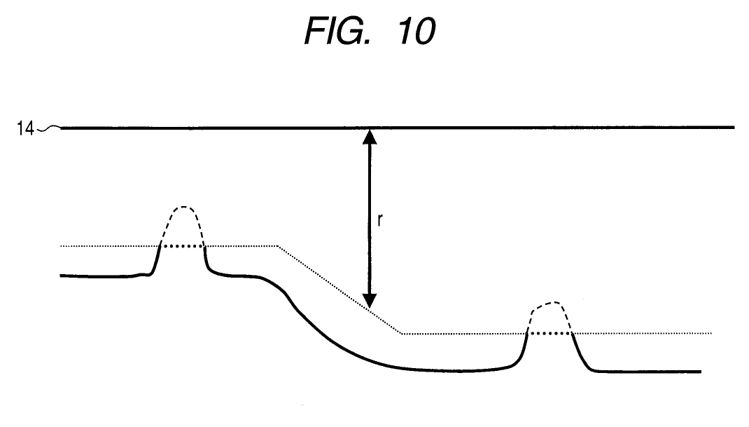

FIG. 10 is a cross-sectional schematic view on a plane parallel with the central path 14 when the reference distance r from the central path 14 is automatically calculated depending on the position on the central path 14. As shown in the figure, the diameter of the tissue varies depending on the position on the central path 14 and thus the reference distance r is changed depending on the position on the central path 14, whereby a projection of the internal surface of the tubular tissue can be displayed as a cylindrical cross-sectional image.

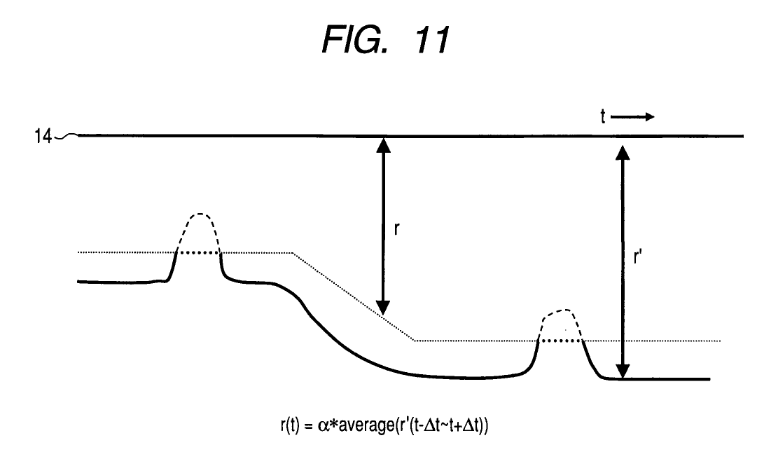

FIG. 11 is a drawing to describe an implementation method of the example. Assuming the actual diameter of the tissue at the position t on the central path 14 to r′(t) (where r′ is the average value of the diameter on the perimeter of the central path 14), reference distance r(t) at the position t can be found according to the following expression:

r(t)=α*average(r′(t−Δt˜t+Δt)) (1)

The purpose of finding the average in the range of ±Δt on the central path is to prevent the value of r(t) from being sharply responsive to a projection part.

The user directly manipulates the reference distance r in example 1; while, the reference distance r is adjusted with α as a coefficient that can be manipulated by the user in example 2. Therefore, α is changed according to the position on the central path 14, whereby a projection of the internal surface of the tubular tissue can be displayed as a cylindrical cross-sectional image.

### EXAMPLE 3

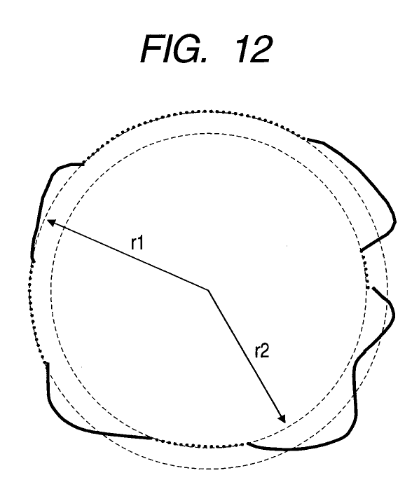

FIG. 12 is a drawing to describe example 3 of the image processing method according to the embodiment of the invention. In the image processing method of the example, the reference distance r1, r2 (r1>r2) from the central path varies depending on the direction from the central path and is calculated automatically.

That is, the diameter of a tubular tissue varies from one place to another and the setup central path does not necessarily pass through the center of the actual tissue and therefore the reference distances r1 and r2 are adjusted according to the direction from the central path. If the central path is a curve (curved cylindrical projection), particularly the central path and the strict center of the tissue is likely to shift and thus the reference distance r is automatically found according to the direction from the central path, whereby a projection of the internal surface of the tubular tissue can be found easily.

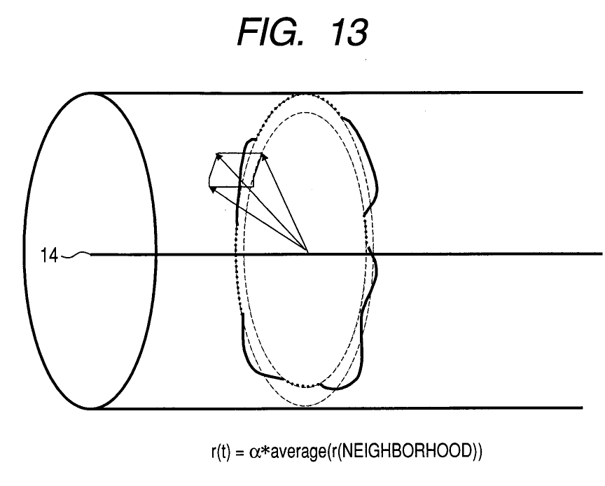

FIG. 13 is a drawing to describe an implementation method of the example of the invention. As shown in the figure, assuming the actual diameter in the neighbor of the part to be found to r (neighborhood), reference distance r(t) can be found according to the following expression:

r(t)=α*average(r(neighbor)) (2)

The user directly manipulates the reference distance r in example 1. Meanwhile, the reference distance r is adjusted with α as a coefficient that can be manipulated by the user in example 2. Therefore, α is changed according to the direction on the central path 14, whereby a projection of the internal surface of the tubular tissue can be displayed as a cylindrical cross-sectional image.

Thus, according to the image processing method of the embodiment) a cylindrical cross-sectional image is pasted on a cylindrical projection image, whereby the inside of a wall and the inner wall surface of a tubular tissue with a large number of bending curvatures such as the colon can be observed at the same time.

In the curved cylindrical projection, an upper limit can be set to the reference distance r. In the curved cylindrical projection, in cases where a bending curvature is large, a plurality of virtual rays may cross each other (see Non-patent Document 1). In such cases, distortion of a cylindrical cross-sectional image becomes large. The distortion becomes large in response to the reference distance r and therefore the upper limit can be set to the reference distance r, whereby the possibility of erroneous diagnosis caused by the distortion of the cylindrical cross-sectional image can be decreased.

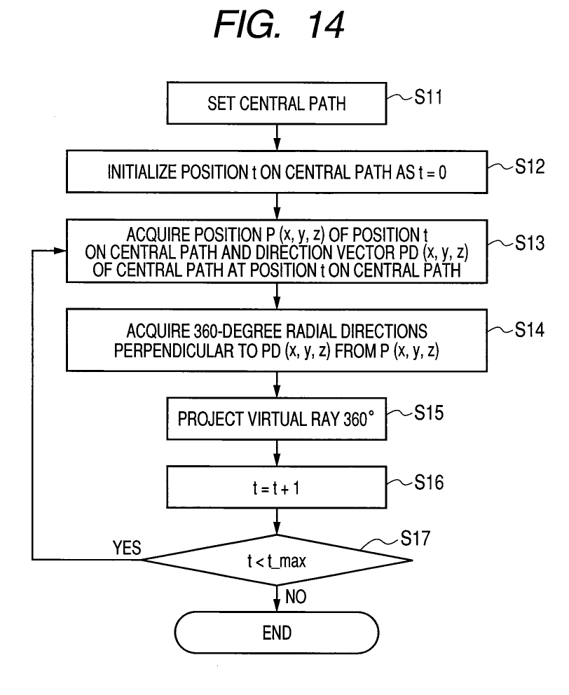

FIG. 14 is a flowchart of the image processing method according to examples 1 to 3 of the invention. In the image processing method of the examples, firstly, a central path is set (step S11) and a position t on the central path is initialized as t=0 (step S12).

Next, a position P (x, y, z) of the position t on the central path and a direction vector PD (x, y, z) of the central path at the position t on the central path are acquired (step S13). 360-degree directions perpendicular to PD (x, y, z) from P (x, y, z) are acquired (step S14). The direction is not necessarily perpendicular in the curved cylindrical projection. To acquire only a partial image, it is not necessary to calculate all the 360-degree directions.

Next, virtual ray is projected 360° (step S15) and 1 is added to τ (step S16) and whether or not t is smaller than t_max is determined (step S17). If t is smaller than t_max (yes), the process returns to step S13 and when t becomes t_max (no), the process is terminated.

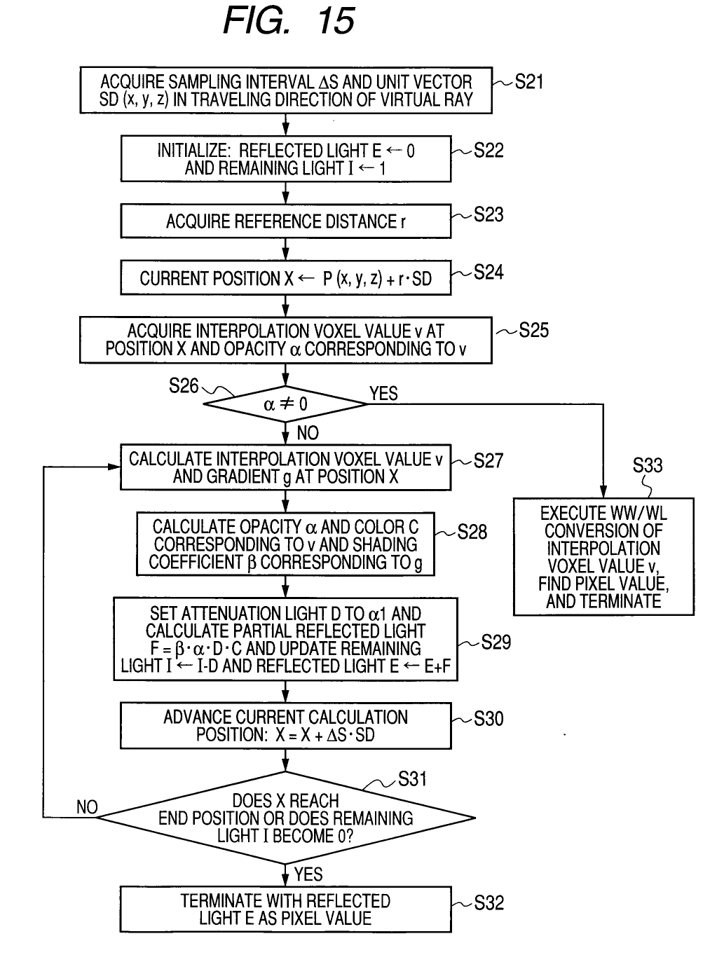

FIG. 15 is a flowchart of calculating pixel values when virtual ray is projected at step S15 in FIG. 14. To project virtual ray, firstly, sampling interval AS and unit vector SD (x, y, z) in the traveling direction of the virtual ray are acquired (step S21). For initialization, reflected light E is set to 0 and remaining light I is set to 1, respectively (step S22).

Next, reference distance r is acquired (step S23) and P (x, y, z)+r·SD is assigned to current position X (“·” represents multiplication) (step S24). In this case, the starting position of projecting the virtual ray need not necessarily be on the central path and may be inside the tissue to be observed. An interpolation voxel value v at the position X and opacity α corresponding to v are acquired (step S25).

Next, whether or not the opacity α is 0 is determined (step S26). If the opacity α is 0 (no), the interpolation voxel value v and gradient g at the position X are calculated according to raycast of the cylindrical coordinate method (step S27). A step of assigning P (x, y, z) to the current position X may be inserted before step S27. In such a case, suspended matter in front is also rendered.

Next, opacity α and color C corresponding to v and a shading coefficient β corresponding to g are calculated (step S28). From attenuation light D=α1 and partial reflected light F=β·α·D·C, the attenuation light D and partial reflected light F are calculated and remaining light I=I−D and reflected light E=E+F are updated (step S29). Usually, the opacity α and the color C are found based on predetermined Look Up Table (LUT) functions.

Next, the current calculation position is advanced and X=X+ΔS·SD (step S30). Whether or not the current position X reaches the end position or whether or not the remaining light I becomes 0 is determined (step S31). If the current position X does not reach the end position and the remaining light I is not 0 (no), the process returns to step S27. On the other hand, if the current position X reaches the end position or the remaining light I becomes 0 (yes), the reflected light E is adopted as pixel value and the process is terminated (step S32).

If it is determined at step S26 that the opacity α is not 0 (yes), interpolation voxel value v is converted into WW/WL (window width/window level), the pixel value is found, and the process is terminated (step S33). This corresponds to acquiring of surface data of the tissue to be observed. The process may be returned to step S26 with semitransparency processing, etc., added before step S33. The inside of a wall and the inner wall surface of a tubular tissue can be represented in a superposition manner by performing the semitransparency processing. The semitransparent degree can be switched with one parameter.

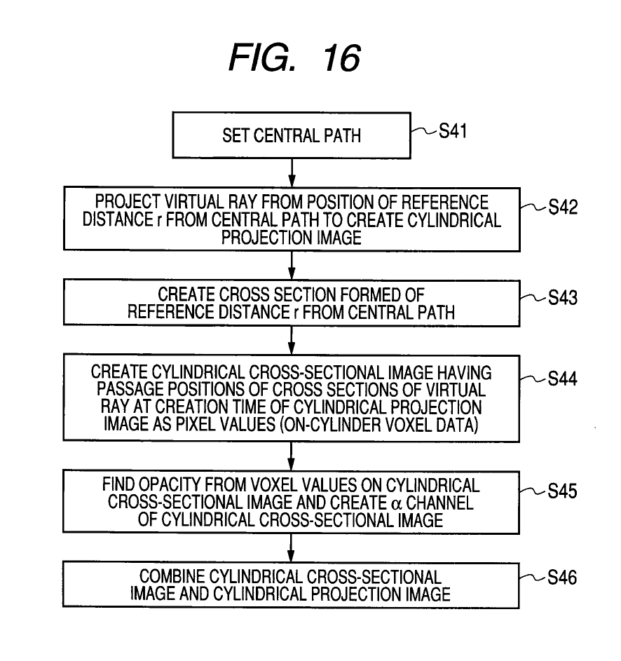

FIG. 16 is a flowchart to show another implementation method in the image processing method of the invention. In the implementation method, firstly, a central path is set (step S41) and virtual ray is projected to the position of the reference distance r from the central path thereby to create a cylindrical projection image (step S42).

Next, a cross section formed at the reference distance r from the central path is created (step S43). A cylindrical cross-sectional image (on-cylinder voxel data) is created which has passage positions of the cross sections of the virtual ray at the creation time of the cylindrical projection image as pixel values (step S44). Opacity is found from the voxel values on the cylindrical cross section using the conversion function used at the calculation time of the cylindrical projection image and an α channel of the cylindrical cross-sectional image is created (step S45) and then the cylindrical cross-sectional image and the cylindrical projection image are combined (step S46).

Further, in order to apply the method to examples 2 and 3 wherein the reference distance r varies and the case where the central path is a curve, since the projection start position, the projection interval, and the projection direction of the virtual ray of the cylindrical projection image vary, it is necessary to record the coordinates of each cross section and make adjustment based on the passage positions of the cross sections of the virtual ray.

As described above, according to the image processing method and the image processing program according to the embodiment of the invention, the inside of a wall of a tubular tissue can be observed based on the image representing the cross section defined by the reference distance r from the central path 14 and the inner wall surface of the tubular tissue can be observed at the same time based on the cylindrical projection image according to the cylindrical projection.

In the algorithms in FIGS. 14 and 15, a composite image of a cylindrical cross-sectional image and a cylindrical projection image is calculated as a harmonious whole and thus can be calculated at higher speed than the cylindrical cross-sectional image and the cylindrical projection image are calculated separately.

For convenience of the description, the term “cylinder” is used; the cylinder in the invention refers to a tubular shape in a broad sense. The cylinder may be curved and has asperities on the circumference and need not form the strict circumference of a circle and need not have a constant length of the circumference. That is, the shape may be any if it is appropriate for representing a tubular tissue such as an intestine, a vessel, or a bronchium.

In examples 1 to 3, the cylindrical cross-sectional image is created according to the two-dimensional cross-sectional image technique; the pixel values are determined using the voxel value on the cylindrical cross section and a mode of using the voxel values of a plurality of voxels is contained. For example, an interpolation value using a plurality of nearby voxels may be used. Further, for example, the average value, the maximum value, or the minimum value of a plurality of voxels in the thickness direction of the cylindrical cross section is used, whereby the S/N ratio of the cylindrical cross-sectional image can be improved.

According to the image processing method of the invention, the inside of a wall of a tubular tissue can be observed based on the cylindrical cross-sectional image on the cross section defined by the reference distance from the path, and the inner wall surface of the tubular tissue can be observed at the same time based on the cylindrical projection image according to the cylindrical projection

According to the image processing method of the invention, a composite image of a cylindrical cross-sectional image and a cylindrical projection image is calculated at once whole and thus can be calculated at higher speed than the cylindrical cross-sectional image and the cylindrical projection image are calculated separately.

According to the image processing method of the invention, the inside of a wall and the inner wall surface of a tubular tissue with a large number of bending curvatures such as the colon can be observed at the same time.

According to the image processing method of the invention, the reference distance is varied and the cross section responsive thereto is displayed, whereby the height of a convex part can be recognized easily and the lesion part to be observed can be observed in detail.

According to the image processing method of the invention, the user can observe the inside of a wall and the inner wall surface of a tubular tissue with a large number of bending curvatures such as the colon without manipulation.

According to the image processing method of the invention, the user can observe the inside of a wall and the inner wall surface of a tubular tissue with a large number of asperities such as the colon without manipulation.

According to the invention, the inside of a wall of a tubular tissue can be observed based on the cylindrical cross-sectional image on the cross section defined by the reference distance from the path and the inner wall surface of the tubular tissue can be observed at the same time based on the cylindrical projection image according to the cylindrical projection.

The invention can be used as the image processing method and the image processing program for enabling the user to simultaneously observe the inside of a wall and the inner wall surface of a tubular tissue with a large number of bending curvatures such as the colon.

While there has been described in connection with the exemplary embodiments of the present invention, it will be obvious to those skilled in the art that various changes and modification may be made therein without departing from the present invention. It is aimed, therefore, to cover in the appended claim all such changes and modifications as fall within the true spirit and scope of the present invention.

What is claimed is:

1. An image processing method of visualizing information of a living body near an imaginary path, said image processing method comprising:
creating a cylindrical cross-sectional image on a cylindrical cross section defined by a reference distance from the imaginary path;
creating a cylindrical projection image according to said imaginary path;
combining the cylindrical cross-sectional image and the cylindrical projection image; and
displaying the combined image.

2. The image processing method of claim 1, further comprising:
determining said reference distance from the path;
acquiring a position on a circumference of a circle determined by the reference distance from the imaginary path on a plane crossing the imaginary path;
determining whether a voxel of said position represents opacity or transparency;
if said voxel represents the opacity,
acquiring a first pixel value from said voxel; and using the first pixel value to create the cylindrical cross-sectional image, and
if said voxel represents the transparency,
acquiring a second pixel value by projecting a virtual ray passing through said position; and using the second pixel value to create the cylindrical projection image.

3. The image processing method of claim 1, wherein the imaginary path is provided along a central path of a curved tubular tissue, and wherein
the cylindrical projection image is generated by projecting a virtual ray from the central path.

4. The image processing method of claim 2, further comprising:
varying the reference distance through a GUI.

5. The image processing method of claim 2, further comprising:
finding the reference distance in response to a position on the imaginary path.

6. The image processing method as claimed in claim 2, further comprising:
determining the reference distance in response to a direction from the imaginary path.

7. An image-analysis apparatus storing a program for executing an image processing method of visualizing information of a living body near an imaginary path, said image processing method comprising:
creating a cylindrical cross-sectional image on a cylindrical cross section defined by a reference distance from the imaginary path;
creating a cylindrical projection image according to said imaginary path;
combining the cylindrical cross-sectional image and the cylindrical projection image; and
displaying the combined image.

8. The image-analysis apparatus of claim 7, wherein said image processing method further comprises:
determining said reference distance from the path;
acquiring a position on a circumference of a circle determined by the reference distance from the imaginary path on a plane crossing the imaginary path;
determining whether a voxel of said position represents opacity or transparency;
if said voxel represents the opacity,
acquiring a first pixel value from said voxel; and using the first pixel value to create the cylindrical cross-sectional image, and
if said voxel represents the transparency,
acquiring a second pixel value by projecting a virtual ray passing through said position; and using the second pixel value to create the cylindrical projection image.

9. The image-analysis apparatus of claim 8, wherein said image processing method further comprises:
finding the reference distance in response to a position on the imaginary path.

10. The image-analysis apparatus of claim 8, wherein said image processing method further comprises:
determining the reference distance in response to a direction from the imaginary path.
